(19) United States
(12) Patent Application Publication
(10) Pub. No.: US 2015/0088636 A1
(43) Pub. Date: Mar. 26, 2015

(54) CLASSIFICATION OF GEOGRAPHIC PERFORMANCE DATA

(71) Applicant: KENSHOO LTD., Tel Aviv (IL)

(72) Inventors: Gilad Armon-Kest, Amirim (IL); Adina Lederhendler, Tel Aviv (IL); Dorit Zilberbrand, Givat Shmuel (IL); Shahar Siegman, Tel Aviv (IL); Yossi Synett, Tel Aviv (IL); Omri Cohen, Tel Aviv (IL); Arriel Johan Benis, Rehovot (IL)

(73) Assignee: KENSHOO LTD.

(21) Appl. No.: 14/555,758

(22) Filed: Nov. 28, 2014

Related U.S. Application Data
(63) Continuation-in-part of application No. 14/472,898, filed on Aug. 29, 2014.
Application No. 14/472,898 is a continuation-in-part of application No. 13/369,621, filed on Feb. 9, 2012, now Pat. No. 8,856,130.
(60) Provisional application No. 61/910,146, filed on Nov. 29, 2013.

(51) Int. Cl. G06Q 30/02

(52) U.S. Cl. CPC G06Q 30/0244; G06Q 30/0205
USPC 705/14.43

(57) ABSTRACT

A system for classification, including: (a) at least one storage apparatus configured to store information pertaining to a set of ad entity performance data associated with different geographic locations; and (b) at least one processor configured to: define a classification scheme for classification of the performance data into classes based on at least the geographic location identifier in a defining process which includes assigning a score to the geographic location identifier, based on a plurality of quantities of successful occurrences of performance data, each of the quantities is a quantity of successful occurrences having a corresponding geographic location identifier; obtain a respective subset of the performance data; determine, with respect to each class of the plurality of classes, an outcome estimation; compute, for an analyzed performance data, a performance assessment.

### CROSS-REFERENCES TO RELATED APPLICATIONS

This application is continuation-in-part of U.S. patent application Ser. No. 14/472,898, entitled “A System, A Method and A Computer Program Product for Performance Assessment”, filed Aug. 29, 2014, which is a continuation-in-part of U.S. patent application Ser. No. 13/369,621, now U.S. Pat. No. 8,856,130, entitled “A System, A Method and A Computer Program Product for Performance Assessment”, filed Feb. 9, 2012.

This application, additionally, claims the benefit of U.S. Provisional Patent Application No. 61/910,146, entitled “Geographic Bid Modifier for Online Advertising”, filed Nov. 29, 2013.

These three applications are incorporated herein by reference in their entirety.

### FIELD OF THE INVENTION

This invention relates to the field of online advertising.

### BACKGROUND OF THE INVENTION

Machine learning may be used to automatically define rules (also referred to as “hypotheses”) from a basic dataset (also referred to as “training data”). The rules which are defined based on the training data may later be used to make predictions about future raw dates. When used for classification, machine learning may be implemented for building, based on the training data, a model of classes distribution in terms of attributed predictor variables, and later using the resulting classifier to assign classes to testing items (also referred to as “instances”), where the attributes of the predictor variable of those instances are known, but the proper classification is unknown.

Every item in the dataset used by machine learning algorithms is represented using the same set of variables (even though, in practice, the information available for each given item may not include information pertaining to each and every one of those variables). The variables may be continuous, categorical or binary.

There are two main categories of machine learning—supervised and unsupervised. If, in the training data, the items are given with known classification (the corresponding correct outputs), then the learning is called supervised, in contrast to unsupervised learning, where classification of items is not provided as part of the training data. Applying of such unsupervised algorithms (also referred to as “clustering” algorithms) may be used to discover unknown, but useful, classes of items.

Classification of items based on a classification scheme generated by machine learning into productivity indicative classes may be implemented in various fields of technology. For example, the expected productivity of a machine, its likelihood of failure and so forth may be estimated based on various attributes of such a machine and on such a classification scheme.

In another example, in the electronic advertising field, effectiveness may be determined, among other criteria, by the ability of the marketer to target his advertisements in a focused and effective way to different audiences. Providing a marketer with reliable information pertaining to finely classified subgroups of such audiences (based on people, search keywords, social media data, etc.) may increase the effectiveness and productivity of marketing systems (and especially advertising systems) used by the marketer.

In many cases, however, information by which such a classification scheme may be generated by machine learning processes is limited. One attempting to generate a classification scheme for classification of search keywords into productivity indicative classes based on attributes of those keywords would, many a time, find out that any information regarding the effectiveness of a great deal of those search keywords is limited, if at all present.

A significant portion out of all the search keywords which are considered relevant by a given marketer may consist of keywords which have infrequently been entered by search engine users, even more infrequently led to advertisements targeting those users, hardly ever resulted in clicking of such an advertisement by a user, and scarcely resulted in a conversion (in which such a user purchased an item, or otherwise acted in a fashion desirable to the marketer).

There is therefore a need to provide effective techniques of performance assessment, and more specifically to performance assessment which is based on classification. There is yet a further need for providing effective techniques of classification based performance assessment of electronic advertising, and of classification based performance assessment in situations in which the training data for a significant part of the training set includes scarce information on which to base determination of productivity.

Advertising using traditional media, such as television, radio, newspapers and magazines, is well known. Unfortunately, even when armed with demographic studies and entirely reasonable assumptions about the typical audience of various media outlets, advertisers recognize that much of their advertising budget is oftentimes simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their advertisements (also “ads”) to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google Inc. of Mountain View, Calif., delivers ads targeted to keywords from search queries.

U.S. patent application Ser. No. 13/032,067, entitled “Method for Determining an Enhanced Value to Keywords Having Sparse Data”, having common inventors with the present application, discloses a method for associating sparse keywords with non-sparse keywords. The method comprises determining from metrics of a plurality of keywords a list of sparse keywords and non-sparse keywords; generating a similarity score for each sparse keyword with respect of each non-sparse keyword; associating a sparse keyword with a non-sparse keyword; and storing the association between the non-sparse keyword and the sparse keyword in a database.

### SUMMARY OF THE INVENTION

One embodiment provides a system for classification, the system comprising: (a) at least one storage apparatus configured to store information pertaining to a set of ad entity performance data associated with different geographic locations, the information being indicative of: a quantity of occurrences, larger than one, of the performance data in a sample, a quantity of successful occurrences of the performance data in the sample, and at least one geographic location identifier of the performance data; and (b) at least one processor configured to: define a classification scheme for classification of the performance data into classes based on at least the geographic location identifier in a defining process which includes assigning a score to the geographic location identifier, based on a plurality of quantities of successful occurrences of performance data, each of the quantities is a quantity of successful occurrences having a corresponding geographic location identifier, obtain a respective subset of the performance data for each out of a plurality of the classes, by applying the classification scheme to geographic location identifiers of a plurality of performance data of the set, determine, with respect to each class of the plurality of classes, an outcome estimation based on quantities of successful occurrences of performance data of the respective subset of performance data of said class, and compute, for an analyzed performance data, a performance assessment which is based on an outcome estimation of a class out of the classes that is a result of application of the classification scheme to geographic location identifiers of the analyzed performance data, thereby enabling a selective application of an industrial process, wherein the selective application is responsive to the performance assessment.

Another embodiment provides a computerized method for classification, the method comprising: (a) storing, in at least one storage apparatus, information pertaining to a set of ad entity performance data associated with different geographic locations, the information being indicative of: a quantity of occurrences, larger than one, of the performance data in a sample, a quantity of successful occurrences of the performance in the sample, and at least one geographic location identifier of the performance data; and (b) using at least one processor to: define a classification scheme for classification of the performance data into classes based on at least the geographic location identifier in a defining process which includes assigning a score to the geographic location identifier, based on a plurality of quantities of successful occurrences of performance data, each of the quantities is a quantity of successful occurrences having a corresponding geographic location identifier, obtain a respective subset of the performance data for each out of a plurality of the classes, by applying the classification scheme to geographic location identifiers of a plurality of performance data of the set, determine, with respect to each class of the plurality of classes, an outcome estimation based on quantities of successful occurrences of performance data of the respective subset of performance data of said class, and compute, for an analyzed performance data, a performance assessment which is based on an outcome estimation of a class out of the classes that is a result of application of the classification scheme to geographic location identifiers of the analyzed performance data, thereby enabling a selective application of an industrial process, wherein the selective application is responsive to the performance assessment.

Yet a further embodiment provides a program storage device readable by machine, tangibly embodying a program of instructions executable by the machine to perform a method for classification, comprising the steps of: (a) storing, in at least one storage apparatus, information pertaining to a set of ad entity performance data associated with different geographic locations, the information being indicative of: a quantity of occurrences, larger than one, of the performance data in a sample, a quantity of successful occurrences of the performance in the sample, and at least one geographic location identifier of the performance data; and (b) using at least one processor to: define a classification scheme for classification of the performance data into classes based on at least the geographic location identifier in a defining process which includes assigning a score to the geographic location identifier, based on a plurality of quantities of successful occurrences of performance data, each of the quantities is a quantity of successful occurrences having a corresponding geographic location identifier, obtain a respective subset of the performance data for each out of a plurality of the classes, by applying the classification scheme to geographic location identifiers of a plurality of performance data of the set, determine, with respect to each class of the plurality of classes, an outcome estimation based on quantities of successful occurrences of performance data of the respective subset of performance data of said class, and compute, for an analyzed performance data, a performance assessment which is based on an outcome estimation of a class out of the classes that is a result of application of the classification scheme to geographic location identifiers of the analyzed performance data, thereby enabling a selective application of an industrial process, wherein the selective application is responsive to the performance assessment.

In some embodiments, each occurrence is partial performance data associated with one of said different geographic locations, and each successful occurrence is complete performance data associated with one of said different geographic locations.

In some embodiments, the selective application comprises determining a geographic bid modifier for an ad entity

In some embodiments, the determining of the geographic bid modifier for the ad entity comprises computing a ratio between: a value per click for the ad entity; and an average value per click across ad entities of all the different geographic locations.

In some embodiments, the value per click and the average value per click are at least partially based on a geographic parameter selected from the group consisting of: a demographic parameter, a business parameter associated with an advertiser, a geographic reach of an advertising platform, weather data and news data.

In some embodiments, the determining of the geographic bid modifier for the ad entity comprises computing a ratio between: a value per impression for the ad entity; and an average value per impression across ad entities of all the different geographic locations.

In some embodiments, the value per impression and the average value per impression are at least partially based on a geographic parameter selected from the group consisting of: a demographic parameter, a business parameter associated with an advertiser, a geographic reach of an advertising platform, weather data and news data.

In some embodiments, the ad entity is selected from the group consisting of: an individual ad, a set of ads, a campaign and a set of campaigns.

In some embodiments, the performance data comprises at least one performance metric selected from the group consisting of: impressions, clicks, click-through rate (CTR), conversions, return on investment (ROI), revenue per click, cost per impression, cost per click, revenue per impression, reach and frequency.

In some embodiments, said at least one processor is further configured to transmit a command to an advertising platform, the command being based on the geographic bid modifier for the ad entity.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A illustrates a system for classification, according to an embodiment of the currently presented subject matter;

FIG. 1B illustrates an operation of the system of FIG. 1A, according to an embodiment of the currently presented subject matter;

FIG. 2 illustrates a computerized classification method, according to an embodiment of the currently presented subject matter;

FIG. 3 illustrates a computerized classification method, according to an embodiment of the currently presented subject matter; and

FIGS. 4A and 4B illustrate a computerized classification method, according to an embodiment of the currently presented subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present currently presented subject matter may be practiced without these specific details. In other instances, well-known methods, procedures, and components have not been described in detail so as not to obscure the present currently presented subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “processing”, “calculating”, “determining”, “generating”, “setting”, “configuring”, “selecting”, “computing”, “assigning”, or the like, include action and/or processes of a computer that manipulate and/or transform data into other data, said data represented as physical quantities, e.g. such as electronic quantities, and/or said data representing the physical objects. The term “computer” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

### GLOSSARY

“Online advertising platform” (or simply “advertising platform”): This term, as referred to herein, may relate to a service offered by an advertising business to different advertisers. In the course of this service, the advertising business serves ads, on behalf of the advertisers, to Internet users. Each advertising platform usually services a large number of advertisers, who compete on advertising resources available through the platform. The competition is oftentimes carried out by conducting some form of an auction, where advertisers bid on advertising resources. The ads may be displayed (and/or otherwise presented) in various web sites which are affiliated with the advertising business (these web sites constituting what is often referred to as a “display network”) and/or in one or more web sites operated directly by the advertising business. To aid advertisers in neatly organizing their ads, advertising platforms often allow grouping individual ads in sets, such as the “AdGroups” feature in Google AdWords (a service operated by Google, Inc. of Mountain View, Calif.). The advertiser may decide on the logic behind such grouping, but it is common to have ads grouped by similar ad copies, similar targeting, etc. Advertising platforms may allow an even more abstract way to group ads; this is often called a “campaign”. A campaign usually includes multiple sets of ads, with each set including multiple ads. An advertiser may control the cost it spends on online advertising by assigning a budget per individual ad, a group of ads or the like. The budget may be defined for a certain period of time.

“Search advertising platform”: A type of advertising platform in which ads are served to Internet users responsive to search engine queries executed by the users. The ads are typically displayed alongside the results of the search engine query. AdWords is a prominent example of a search advertising platform. In AdWords, advertisers can choose between displaying their ads in a display network and/or in Google's own search engine; the former involves the subscription of web site operators (often called “publishers”) to Google's AdSense program, whereas the latter, often referred to as SEM (Search Engine Marketing), involves triggering the displaying of ads based on keywords entered by users in the search engine.

“Social advertising platform”: A further type of advertising platforms, commonly referred to as a “social” advertising platform, involves the displaying of ads to users of online social networks. An online social network is often defined as a set of dyadic connections between persons and/or organizations, enabling these entities to communicate over the Internet. In social advertising, both the advertisers and the users enjoy the fact that the displayed ads can be highly tailored to the users viewing them. This feature is enabled by way of analyzing various demographics and/or other parameters of the users (jointly referred to as “targeting criteria”)—parameters which are readily available in many advertising platforms of social networks and are usually provided by the users themselves. Facebook Ads, operated by Facebook, Inc. of Menlo Park, Calif., is such an advertising platform. LinkedIn Ads, by LinkedIn Corporation of Mountain View, Calif., is another.

“Online ad entity” (or simply “ad entity”): This term, as referred to herein, may relate to an individual ad, or, alternatively, to a set of individual ads, run by an advertising platform. An individual ad, as referred to herein, may include an ad copy, which is the text, graphics and/or other media to be served (displayed and/or otherwise presented) to users. In addition, an individual ad may include and/or be associated with a set of parameters, such as searched keywords to target, geographies to target, demographics to target, a bid for utilization of advertising resources of the advertising platform, and/or the like. Sometimes, the bid may set for a particular parameter instead of or in addition to setting a global bid for the ad entity; for example, a bid may be per keyword, geography, etc.

“Reach”: the number of users which fit certain targeting criteria of an ad entity. This is the number of users to which that ad entity can be potentially displayed. The “reach” metric is common in social advertising platforms, such as Facebook.

“Search volume”: the number of average monthly searches (or searches over another period of time) for a certain search term. The search volume is often provided by search advertising platforms, such as Google AdWords.

“Performance”: This term, as referred to herein with regard to an ad, may relate to various statistics gathered in the course of running the ad. A “running” phase of the ad may refer to a duration in which the ad was served to users, or at least to a duration during which the advertiser defined that the ad should be served. The term “performance” may also relate to an aggregate of various statistics gathered for a set of ads, a campaign, etc. The statistics may include multiple parameters (also “performance metrics”), whose values are referred to as “performance data”. Exemplary performance metrics are:
“Impressions”: the number of times the ad has been served to users during a given time period (e.g. a day, an hour, etc.);
“Frequency”: the average number of times a user has been exposed to the same ad, calculated as the ratio of total number of impressions to the number of unique impressions (i.e. the number of unique users exposed to that ad). This metric is very common in social advertising platforms;
“Clicks”: the number of times users clicked (or otherwise interacted with) the ad entity during a given time period (e.g. a day, an hour, etc.);
“Cost per click (CPC)”: the average cost of a click (or another interaction with an ad entity) to the advertiser, calculated as the total cost for all clicks divided by the number of clicks;
“Cost per impression”: the average cost of an impression to the advertiser, calculated as the total cost for all impressions divided by the number of impressions;
“Click-through rate (CTR)”: the ratio between clicks and impressions of the ad entity, namely—the number of clicks divided by the number of impressions;
“Conversions”: the number of times in which users who clicked (or otherwise interacted with) the ad entity have consecutively accepted an offer made by the advertiser during a given time period (e.g. a day, an hour, etc.). For examples, users who purchased an advertised product, users who subscribed to an advertised service, users who downloaded a mobile application, or users who filled in their details in a lead generation form;
“Conversion rate (CR)”: the total number of conversions divided by the total number of clicks;
“Return on investment (ROI)” or “Return on advertising spending (ROAS)”: the ratio between the amount of revenue generated as a result of online advertising, and the amount of investment in those online advertising efforts. Namely—revenue divided by expenses;
“Revenue per click”: the average amount of revenue generated to the advertiser per click (or another interaction with an ad entity), calculated by dividing total revenue by total clicks;
“Revenue per impression”: the average amount of revenue generated to the advertiser per impression of the ad entity, calculated by dividing total revenue by total impressions;
“Revenue per conversion”: the average amount of revenue generated to the advertiser per conversion, calculated by dividing total revenue by total conversions;
“Unique-impressions-to-reach ratio”: the ratio between the number of unique impressions (i.e. impressions by different users, ignoring repeated impressions by the same user) and the reach of the ad entity. This ratio represents the realized portion of the reach.
“Spend rate”: the percentage of utilized budget per a certain time period (e.g. a day) for which the budget was defined. In many scenarios, even if an advertiser assigns a certain budget for a certain period of time, not the entire budget is consumed during that period. The spend rate metric measures this phenomenon.
“Quality score”: a score often provided by advertising platforms for each ad entity. For example, Google AdWords assigns a quality score between 1 and 10 to each individual ad. Factors which determine the quality score include, for example, CTR, ad copy relevance, landing page quality and/or other factors. The quality score, together with the bids placed by the advertiser, are usually the factors which affect the results of the competition between different advertisers on advertising resources.
“Potential reach”: defined as 1 minus the unique-impressions-to-reach ratio. The higher the potential reach, the more users are left to display the ad entity to.
“Proportional performance metrics”: those of the above performance metrics (or other performance metrics not discussed here) which denote a proportion between two performance metrics which are absolute values. Merely as one example, CTR is a proportional performance metric since it denotes the proportion between clicks (an absolute value) and impressions (another absolute value). As an alternative, a proportional performance metric may be a proportion between an absolute performance metric and another parameter, such as time. As yet another alternative, a proportional performance metric may be a certain mathematic manipulation of a proportion between two absolute performance metrics; the “potential reach” is an example, since it is defined as 1 minus the unique-impressions-to-reach ratio.

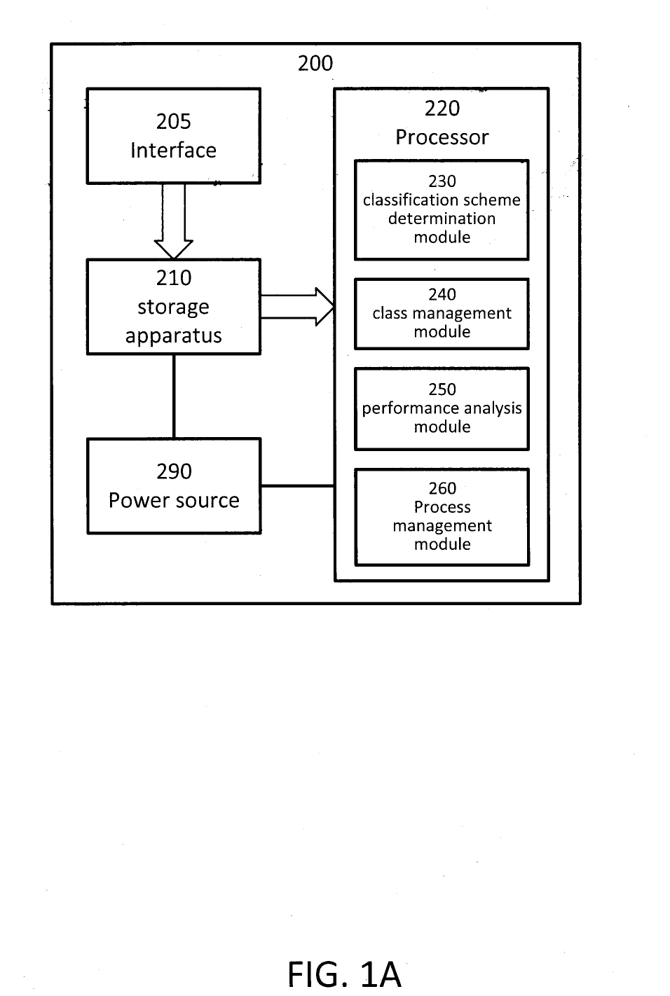

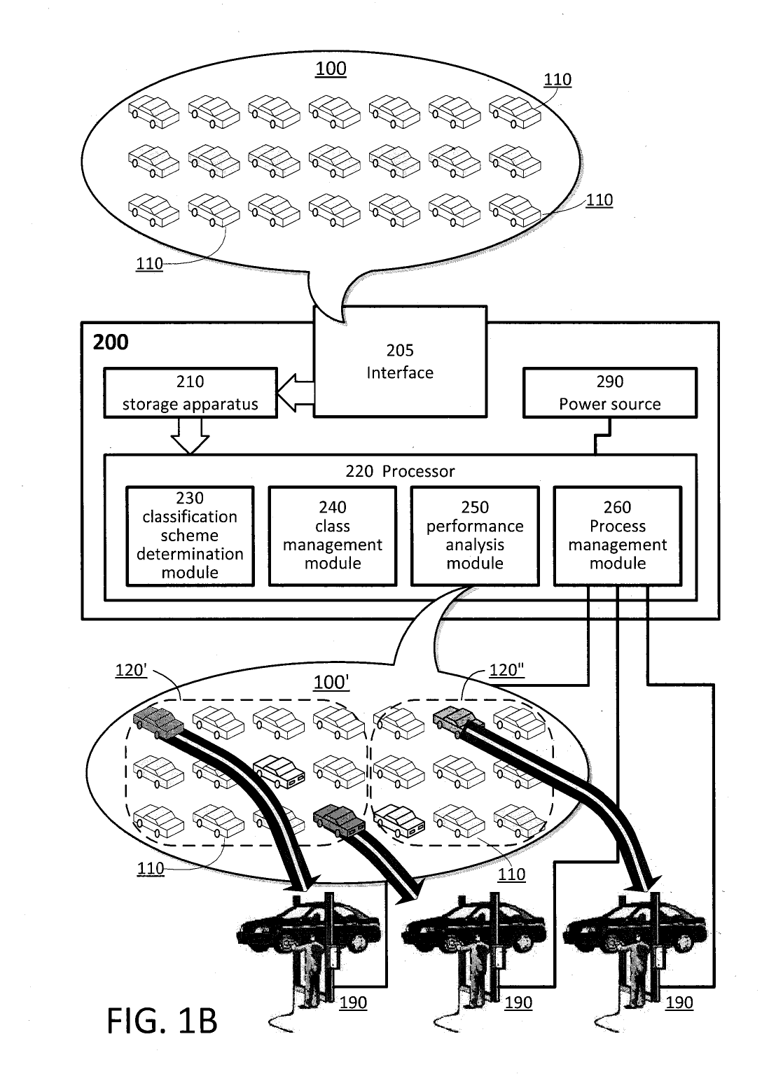

FIG. 1A illustrates system 200 which is a system capable of classifying items in accordance with certain embodiments of the currently presented subject matter. As will be discussed below in greater detail, system 200 may be used for classification of a wide range of entities, one example of which is performance data of ad entities, the data being associated with different geographic locations in which the ad entities have been run. Furthermore, system 200 may be further configured to utilize the classification results by further processing the classified entities. Some of the ways in which system 200 may operate will become clearer when viewed in the light of methods 500, 600 and 800 discussed below.

System 200 may be advantageous, for example, in the computation of a geographic bid modifier in online advertising. The geographic bid modifier (or simply “bid modifier”), in an exemplary embodiment thereof, may be a coefficient according to which advertising resources are allocated to different geographic locations. By way of example, the coefficient pertaining to a certain geographic location may be a multiplier (smaller than 1, equal to 1, or larger than 1) of an average allocation of advertising resources across a larger geographic region which includes that certain geographic location.

Advantageously, the computed bid modifier is representative of the expected value of having a certain advertisement displayed to users in different geographic locations. For example, the value of displaying an advertisement to users in location A may be $1 per user, whereas the value of displaying the same advertisement to users in location B is $2 per user. This value, which is commonly hidden from the advertiser, may be exposed and utilized in the course of employing present embodiments. Trying to define a bid modifier without knowing this value may be doomed to fail; the resulting bid modifier is likely to be arbitrary, lacking basis in the factual value of advertising to the different locations.

Further advantageously, present embodiments may enable the computation of a parameter associated with an advertising value of a geographic location, for example, a bid modifier, even for a geographic location (or a plurality thereof) for which there is no complete performance data available. For example, if the performance data available for an ad entity ran in Cupertino, Calif. is only partial (e.g. is lacking one or more performance metrics, or includes a statistically insignificant amount of data of one or more metrics), then the present classification method may find one or more other geographic locations (e.g., Redmond, Wash.) in which the performance data is similar enough to that in Cupertino; then, the bid modifier for Cupertino may be set as identical or similar to that of Redmond.

System 200 includes storage apparatus 210, which is configured to store information pertaining to each item of a set of items, the information being indicative of: (a) a quantity of occurrences of the item in a sample; (b) a quantity of successful occurrences of the item in the sample; and (c) at least one attribute of the item with regard to at least one variable out of a set of variables. In an embodiment, the attribute is a geographic location identifier, for example the name of a geographic location or any other unique numerical or textual designation of that location.

It is noted that the quantities of different occurrences may differ from each other. Also, the quantity of occurrences of at least one of the items may be larger than one. Examples of ways in which classification scheme determination module 230 may operate are discussed in further detail in relation to methods 500, 600, and 800, and especially to stages 515, 615, and 815 thereof (respectively). The information stored in storage apparatus 210 may be obtained from various sources. For example, it may be generated by processor 220, and/or received from an external source (e.g. by interface 205), such as an API (Application Programming Interface) of an advertising platform.

A given item, in an embodiment, may be ad entity performance data associated with a certain different geographic location, to be classified for further selective application of a respective industrial process.

System 200 also includes at least one processor, referred to herein, for simplicity of discussion, as a single processor 220. Processor 220 may be a general purpose processing module (incorporating hardware and possibly firmware and/or software as well) specially configured for the desired purpose by a computer program stored in a non-transitory computer readable storage medium accessible during processing. Optionally, processor 220 may include dedicated processing module (whether analog, digital, or any appropriate combination thereof), which includes hardware (and possibly firmware and/or software as well) designed dedicatedly for the functions described below. Examples of ways in which processor 220 may operate are discussed in further detail in relation to methods 500, 600, and 800, and especially to stages 520-550, 620-650, and 820-850 thereof (respectively). Those equivalents may be implemented by modules such as modules 230, 240, 250, and/or 260, but this is not necessarily so, and other modules may be implemented as well.

Processor 220 may be configured to execute program instructions of a classification scheme determination module 230, which is configured to define a classification scheme for classification of items into classes based on at least one of the variables in a defining process which includes assigning a score to a variable out of the at least one variable, based on a plurality of quantities of successful occurrences of items, each of the quantities is a quantity of successful occurrences having a corresponding attribute out of a plurality of attributes of the variable. Examples of ways in which classification scheme determination module 230 may operate are discussed in further detail in relation to methods 500, 600, and 800, and especially to stages 520, 620, and 820 thereof (respectively).

Processor 220 may be further configured to execute program instructions of a class management module 240, configured to obtain a respective subset of the plurality of items for each out of a plurality of the classes, by applying the classification scheme to attributes of a plurality of items of the set; and to determine, with respect to each class of the plurality of classes, an outcome estimation based on quantities of successful occurrences of items of the respective subset of items of said class. Examples of ways in which class management module 240 may operate are discussed in further detail in relation to methods 500, 600, and 800, and especially to stages 530, 630, and 830 thereof (respectively).

Processor 220 may be further configured to execute program instructions of a performance analysis module 250, which is configured to compute for an analyzed item a performance assessment which is based on an outcome estimation of a class out of the classes that is a result of application of the classification scheme to attributes of the analyzed item, thereby enabling a selective application of an industrial process, wherein the selective application is responsive to the performance assessment. In an embodiment, the selective application comprises determining a geographic bid modifier for an ad entity. Namely, the outcome estimation may allow setting a geographic bid modifier even for a geographical locating that is missing some performance data.

The determining of the geographic bid modifier may include a computation of a ratio between a value per click, impression or a different performance metric for the ad entity, and an average value per click, impression or the different performance metric, respectively, across ad entities of all the different geographic locations.

Optionally, the value per click, impression or the different performance metric, as well as the average value per click, impression or the different performance metric, are at least partially based on a geographic parameter. Exemplary geographic parameters include:

Statistic (General) Data:
Population.
Percentage of population with college degree.
GDP (gross domestic product).
Per capita income.
Population density.

Geographical Attributes:
Geographical region (e.g. North-East, South, etc.).

Advertiser or Business-Related Data:
Number/density of branches in location.
General revenue of product per location.

Reach of the Advertising Platform:
Target audience of the platform, e.g. Facebook, segmented geographically.

Other Third Party Data:
Weather data per location.
Check-in/location data (e.g. from Foursquare, Facebook).
Listing data (Yellow pages, City Grid).
Local news event (festivals, disaster, health, sports, etc.).

Consider the following example of applying a geographic bid modifier: A certain advertiser wishes to allocate its advertising budget to advertising to U.S.-based users. However, the advertiser wishes to set different bids for displaying ads in different U.S. states. This, as a function of the utility that advertiser derives from advertising to different locations. In accordance with present embodiments, the advertiser may provide its historical performance data of the pertinent ad entity, for example a campaign. The historical performance data may be segmented according to different U.S. states. However, one or more of these states may lack complete performance data, hence making it difficult or even impossible to compute a bid modifier for them. Advantageously, the present classification techniques may be used to fill in this gap, by classifying together performance data of states in which the performance has certain similarities. Consequently, a bid modifier for a state which lack complete performance data may be deduced based on performance data of a different state, with which it was classified. In addition, the provider may optionally provide advertiser-defined attributes of the different geographic regions. Then, a value per click in each U.S. state is computed. Let us assume that the value per click in Washington State is $1, and in New York State is $2. The average value per click across all 50 states is $1. Accordingly, the computed bid modifier for Washington will be 1 (e.g. no change from the average) and for New York 2 (e.g. 100% over the average). After being presented with these bid modifiers, the advertiser may manually enter them into the pertinent advertising platform, to affect the future bids of its ad entities. Alternatively, these bid modifiers may be automatically communicated to the advertising platform, for enhanced convenience of the advertiser.

Further examples of ways in which performance analysis module 250 may operate are discussed in further detail in relation to methods 500, 600, and 800, and especially to stages 540, 640, and 840 thereof (respectively).

Processor 220 may be further configured to execute program instructions of a process management module 260, which is configured to instruct (and possibly also to monitor and/or otherwise manage) one or more industrial processes, in response to the performance assessment. Examples of ways in which process management module 260 may operate are discussed in further detail in relation to methods 500, 600, and 800, and especially to stages 550, 650 and 850 thereof (respectively).

As aforementioned, each of the modules or components of system 200 may be implemented in software, hardware, firmware, or any appropriate combination thereof. These software, hardware, firmware or their combination may be accessible to processor 220, such that the processor may receive the program instructions and execute them. Additionally, system 200 may also include other components that are not illustrated, and whose inclusion will be apparent to a person who is of skill in the art—e.g. a power source 290, a display, etc.

FIG. 1B illustrates an operation of the system of FIG. 1A, according to an embodiment of the currently presented subject matter, and is discussed below, after the discussion of method 500.

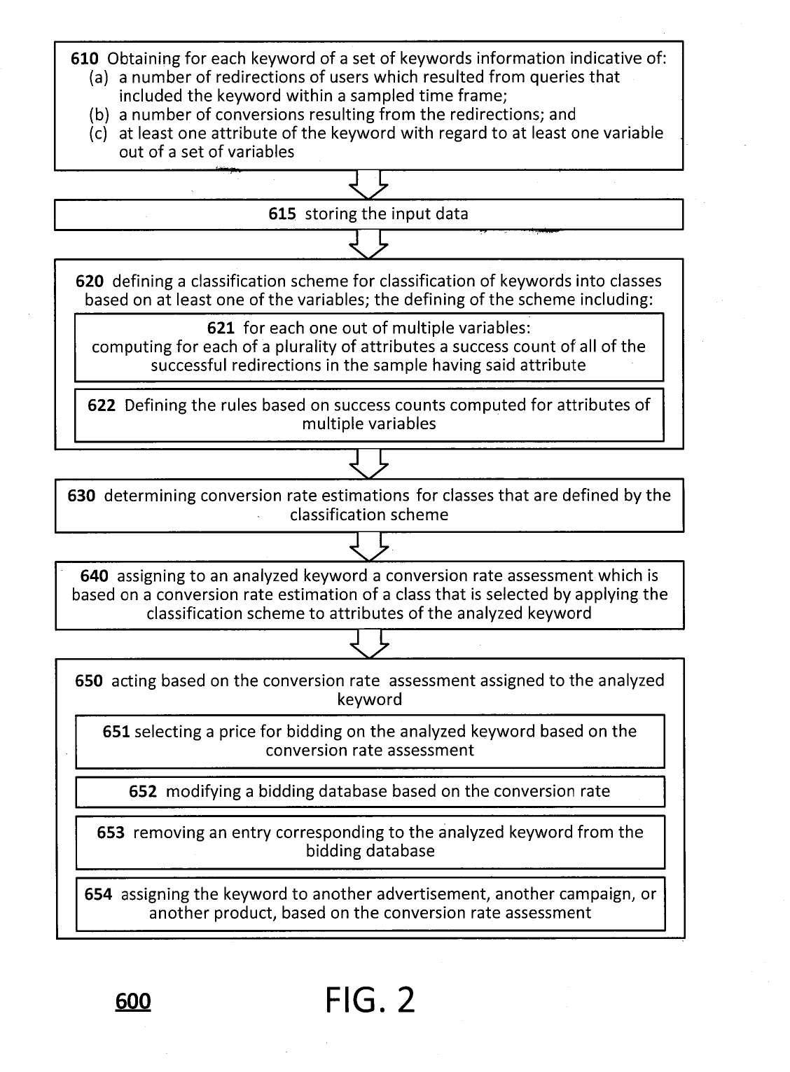

FIG. 2 illustrates computerized classification method 600, according to an embodiment of the currently presented subject matter. It should be noted that method 600 is a potential implementation of method 500 which is discussed below. The discussion of the more general method 500 is believed to be more easily understood in view of the discussion of method 600, and therefore this discussion is presented prior to the discussion of method 500.

Classification method 600 is a variation of method 500 which is used to classify ad entity performance data associated with different geographic locations into classes of geographic locations, and to determine for those classes conversion rate estimations (which may later be put to use). Each numbered stage of method 600 corresponds to an equivalent stage of method 500 whose number is smaller by 100. For example, stage 610 is an implementation of stage 510, and so forth.

Referring to the examples set forth in the previous drawings, method 600 may be executed by a system such as system 200. Embodiments, variations and possible implementations discussed with relation to method 600 may be applied to system 200, mutatis mutandis, even if not explicitly elaborated, and vice versa.

Method 600 may start with stage 610 which includes obtaining input data. It should be noted that the input data may be generated as part of method 600, and/or may be received from an external system. Stage 615 includes storing the input data in a storage apparatus (e.g. one or more magnetic disks). Since stages 610 and 615 pertain to the same type of data (even though not all of the input data which is generated in stage 610 is necessarily stored in stage 615 or used in further stages of method 600), variations regarding the input data will be discussed in relation to stages 610 and 615 together. Referring to the examples set forth in the previous drawings, stage 610 may be carried out by an interface such as interface 205, and stage 615 may be carried out by a storage apparatus such as storage apparatus 210.

The input data pertains to a set of ad entity performance data associated with different geographic location, and to usage information which pertains to the geographic locations of the set. For example, the set of ad entity performance data may be associated with the geographic locations which are selected by an advertiser for bidding in an advertising platform.

Assessing the performance of ad entities run in different geographic locations may be based on performance within a sampled time frame (e.g. a week). For example, table 1 illustrates the performance of various ad entities run in different geographic locations associated with a creative advertising discounted telephone service within a week in a theoretical search engine.

TABLE 1

| | Times an ad | Times an ad | Times a purchase |
|---|---|---|---|
| | was displayed | was clicked | was made |
| Geographic location | (impressions) | (clicks) | (conversions) |
| Cupertino, CA | 12 | 2 | 0 |
| Redmond, WA | 101 | 8 | 1 |
| Mountain View, CA | 82 | 5 | 1 |
| Atlanta, GA | 0 | 0 | 0 |
| . . . | . . . | | |
| Tel Aviv, Israel | 23 | 3 | 2 |

Stage 615 includes storing in the storage apparatus information pertaining to each performance data of the set of performance data, the information being indicative of:
a number of redirections of users which resulted from queries in a certain geographic location within a sampled time frame (e.g. a number of times in which users in that geographic location clicked advertisements presented in response to queries within a sampled time frame);
a number of conversions resulting from the redirections (e.g. a number of purchases made by users following such clicks within the sampled time frame); and
at least one attribute of the geographic location, which attribute may be, for example, a geographic location identifier.

Stage 610 may include receiving this information for some or all of the performance data of the set. It should be noted that the stored information is indicative that at least one of the performance data are associated with multiple redirections (either by a single user or by several users).

Stage 620 of method 600 includes defining a classification scheme. For example, the classification scheme may include one or more classification rules (therefore, the term “classification rules” is also used to refer to the classification scheme). The classification scheme defined in method 600 may be used for classification of performance data of different geographic locations into classes, wherein each performance data of a certain geographic location is classified into one (or more) of the classes based on its attributes (e.g. its geographic location identifier) with regard to at least one of the variables of the aforementioned set of variables. The number of classes may be a predetermined number, or may be determined during the process of defining. Referring to the examples set forth in the previous drawings, stage 620 may be carried out by a classification scheme determination module such as classification scheme determination module 230.

The defining of the calibration scheme in stage 620 includes at least stages 621 and 622. Stage 621, which is repeated for each one out of a plurality of variables, includes computing for each out of a plurality of attributes of one of the variables a success count of successful redirections in the sample which are associated with said attribute. Optionally, stage 621 includes computing a success count may relate to those geographic locations which have complete performance data, out of all geographic locations which may sometimes have only partial performance data.

As explained in more detail with respect to method 800, the success count may pertain to only a subsample of the entire sample, and not to the entire sample. For example, the success count of a first attribute may be calculated for a subset of the sample which is characterized by having another attribute.

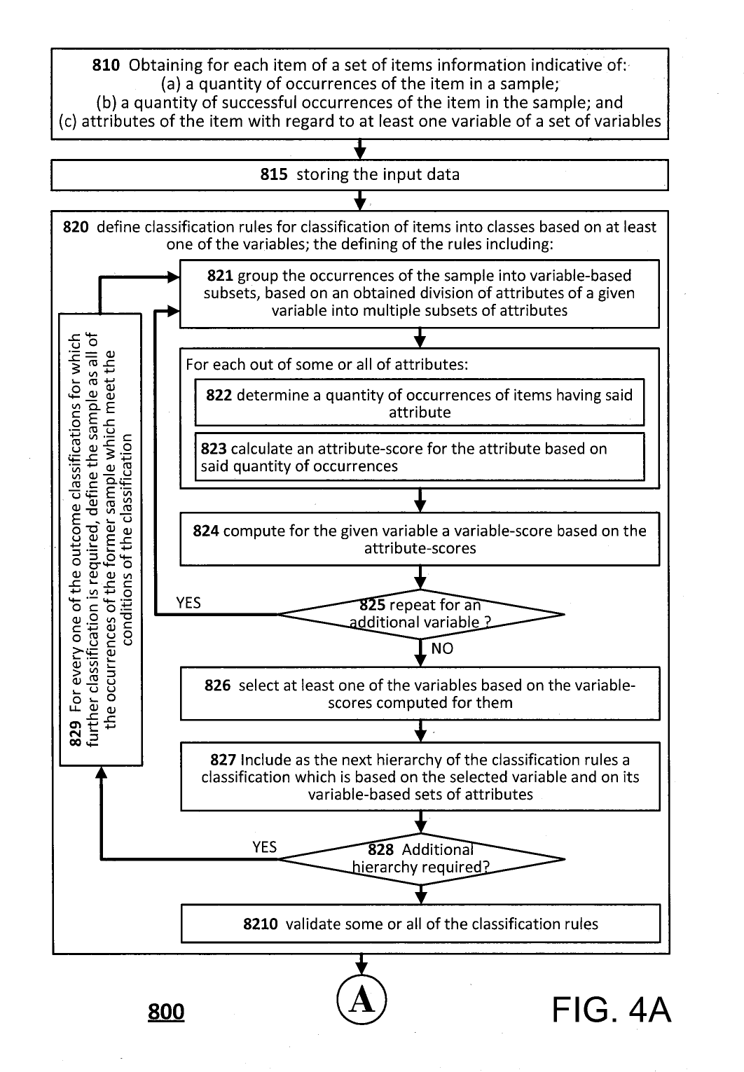

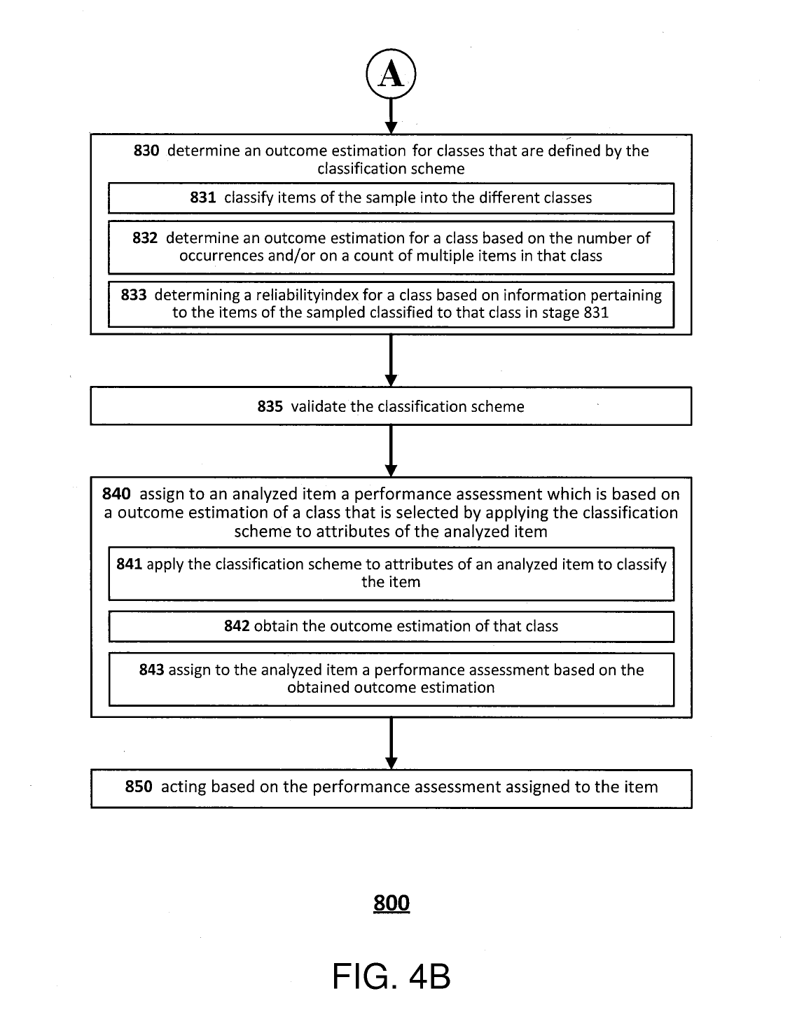

As illustrated by stage 622, the defining of the classification scheme in stage 620 is based on success counts computed for attributes of multiple variables. Some of the ways in which stage 620 may be implemented are discussed below in more detail, e.g. with respect to FIG. 4A.

The defining of the classification scheme may be irrespective of a success rate of any item of the set of items (that is, the ratio between the quantity of successful occurrences of any item and its quantity of overall occurrences, is not used in the process).

Stage 630 of method 600 includes determining conversion rate estimations for classes that are defined by the classification scheme. Some ways in which the conversion rate estimations of the different classes may be determined are discussed below. Referring to the examples set forth in the previous drawings, stage 630 may be carried out by a class management module such as class management module 240.

It should be noted that the applying the classification scheme to performance data of a geographic location (based on its attributes) results in a selection of one (or more) out of a finite number of classes, to which conversion rate estimations are determined in stage 630.

The conversion rate estimation determined for each class may later be put to use for assigning to geographic location performance assessments which are based on the conversion rate estimations of the respective classes to which such performance data are classified. For example, the conversion rate estimation of each class may be a number between 0 and 1, and for each performance data of a geographic location a conversion rate assessment of that performance data may be assigned, based on the conversion rate estimation determined to the class.

The determining of the conversion rate estimation for a class in stage 630 may be based on the number of clicks of some or all of the performance data in that class. For example, the determining of the conversion rate estimation for a class in stage 630 may be based on the sum of clicks of all of the performance data of the sample which are classified to that class based on the classification scheme.

The determining of the conversion rate estimation for a class in stage 630 may also be based (in addition to the formerly discussed number of occurrences of geographic location identifiers in the class, or regardless thereof) on a count of multiple geographic location identifiers in that class (which are classified to that class by applying the classification scheme to the attributes of those geographic location identifiers). For example, while all of the geographic location identifiers which are classified to that class based on the classification scheme may be counted in that count, in another implementation only geographic location identifiers that have non-zero number of clicks (and possibly all of them) are counted.

A more detailed discussion of some of the ways in which the conversion rate estimation may be determined in stage 630 is provided with respect to stages 530 and 830 of methods 500 and 800 correspondingly. This discussion is not repeated with respect to method 600 for reasons of brevity only, and the variations discussed with respect to stages 530 and/or 830 may be implemented in stage 630, mutatis mutandis.

While not necessarily so, the determining of the conversion rate estimation in stage 630 may be irrespective of data pertaining to geographic location identifiers of the sample which are not included in that class. As is discussed below in greater detail (especially with respect to method 500), method 600 may also include determining additional parameters for classes that are defined by the classification scheme, based on information of geographic location identifiers of the samples which are classified to the respective classes.

Stage 640 of method 600 includes assigning to an analyzed performance data of a geographic location a conversion rate assessment which is based on the conversion rate estimation of one of the classes. The conversion rate estimation which is used is the one that is determined in stage 630 to the class which results from application of the classification scheme to attributes of the analyzed performance data. Referring to the examples set forth in the previous drawings, stage 640 may be carried out by a performance analysis module such as performance analysis module 250.

It is noted that execution of stage 640 enables a selective application of an industrial process, wherein the selective application of the industrial process is responsive to the performance assessment. In an embodiment, the selective application comprises determining a geographic bid modifier for an ad entity.

Optional stage 650 includes acting based on the conversion rate assessment assigned to the performance data of a specific geographic location. For example, stage 650 may include executing one or more of stages 651 through 654.

Stage 651 includes selecting a price for bidding for the specific geographic location based on the conversion rate assessment (and possibly on other parameters as well).

Stage 652 includes modifying a bidding database based on the conversion rate assessment (e.g. based on the price selected in stage 651). Stage 652 may include updating an entry that is associated with the analyzed performance data in a bidding database based on the conversion-rate assessment, e.g. thereby facilitating cost reduction in a bidding process that depends on the analyzed performance data.

Stage 653 includes removing an entry corresponding to specific geographic targeting of an ad entity from the bidding database (e.g. because the conversion rate assessment assigned to this geographic location is below a predetermined threshold).

Stage 654 includes assigning the specific geographic targeting to another advertisement, another campaign, or another product, based on the conversion rate assessment (and possibly on other parameters as well, e.g. such as the conversion rate assessment assigned to this geographic location based on a classification scheme devised for another advertisement).

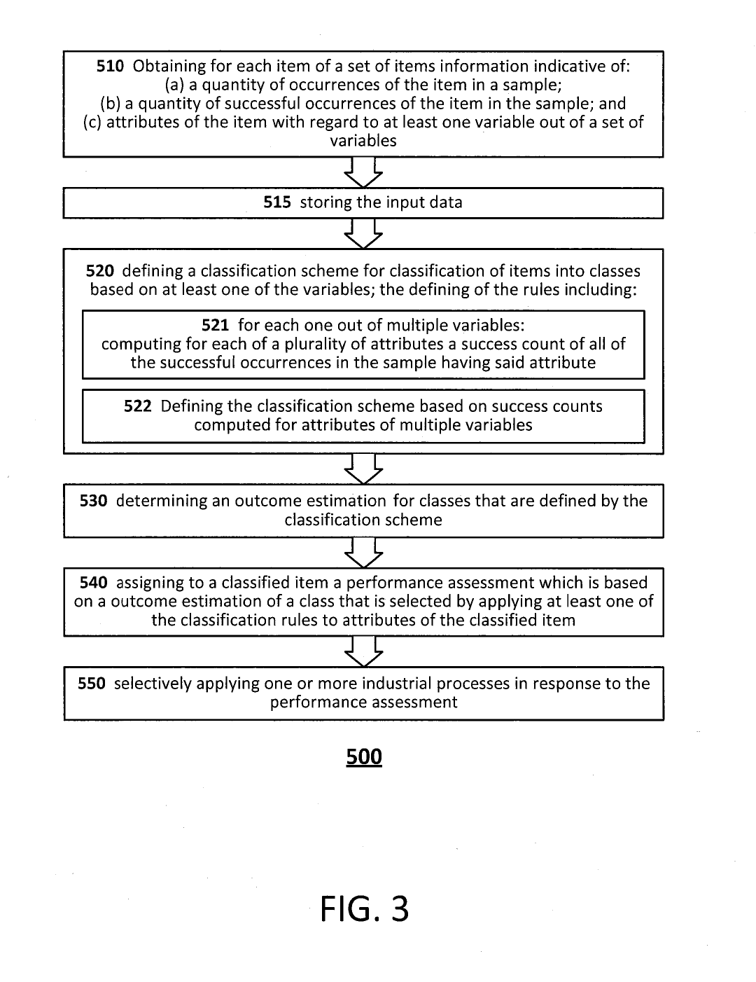

FIG. 3 illustrates computerized classification method 500, according to an embodiment of the currently presented subject matter. Referring to the examples set forth in the previous drawings, method 500 may be executed by a system such as system 200. Embodiments, variations and possible implementations discussed with relation to method 500 may be applied to system 200 mutatis mutandis even if not explicitly elaborated, and vice versa.

Referring to the examples set forth in the previous drawings, method 500 may be carried out by system 200. Different embodiments of system 200 may implement the various disclosed variations of method 500 even if not explicitly elaborated. Likewise, different embodiments of method 500 may include stages whose execution fulfills the various disclosed variations of system 500, even if succinctness and clarity of description did not necessitate such repetition.

Some of the stages of method 500 refer to a set of items and to information associated with each of these items, and to a classification scheme which is defined based on the information associated with the items of the set. This classification scheme may be applied to classify items of the set, and may possibly also be applied for classification of other items.

In some implementations, method 500 may be used for inferring a classification scheme from training data which consist of a set of training examples. However, as is demonstrated below in more detail, the different items of the training set are not necessarily associated with a desired output value.

Method 500 may be utilized in a wide range of fields, and the examples provided are provided as illustrative examples only, and are not intended to limit the scope of the currently presented subject matter in any appropriate way.

Method 500 may start with stage 510 which includes obtaining input data. It should be noted that the input data may be generated as part of method 500, and/or may be received from an external system. Stage 515 includes storing the input data in a storage apparatus (e.g. one or more magnetic disks). Since stages 510 and 515 pertain to the same type of data (even though not all of the input data which is generated in stage 510 is necessarily stored in stage 515 or used in further stages of method 500), variations regarding the input data will be discussed with relation to stages 510 and 515 together. Referring to the examples set forth in the previous drawings, stage 510 may be carried out by an interface such as interface 205, and stage 515 may be carried out by a storage apparatus such as storage apparatus 210.

Stage 515 includes storing in the storage apparatus information pertaining to each performance data of the set of performance data, the information being indicative of:
A quantity of occurrences of the item in a sample;
A quantity of successful occurrences of the item in the sample; and
One or more attributes of the geographic location, which attribute may be, for example, a geographic location identifier.

Stage 510 may include receiving that information for some or all of the performance data of the set. It should be noted that the stored information is indicative that at least one of the performance data is associated with multiple redirections (either by a single user or by several users).

It should be noted that the obtained information may explicitly include the quantity of occurrences of the item in the sample, the quantity of successful occurrences of the item in the sample, and/or the attributes of the item, but may alternatively include information from which such data may be inferred. For example, the obtained information may include the quantity of occurrences of the item in the sample and the ratio of successful occurrences out of those, and the quantity of successful occurrences may be inferred by multiplying those two numbers.

The set of items may also be referred to as the “training set”, and may include items of one or more types. Without limiting the scope of the currently presented subject matter, a few examples of implementations of the sample are: some or all of the events occurred in real life within a predetermined span of time (with or without filtering those based on some qualification criterion), may pertain to all of the items in a collection (e.g. all of the cars which are currently operated by a car rental company), may be a computer generated sample (e.g. a result of a simulation, of a so-called Monte Carlo random sample generation), and so forth.

Each of the items of the sample has a quantity of occurrences which is associated with it. For example, for a sample of search query strings, the quantity of occurrences may be equal to the number of times the respective search query was used by users of a given search engine in a sampled period of time (e.g. a given week). In another example, for a sample of cars, the number of occurrences may be the number of times each car had to be sent to a central garage—either in a given time span (e.g. last business year) or regardless of such a time span (e.g. since the manufacturing of each respective car).

The quantity of occurrences may be a positive integer, and may also be a non-negative integer (for example, it is possible that some of the search queries were not used during the sampling duration or that a car was not sent to the central garage). In some implementations of the currently presented subject matter, quantity of occurrences which are non-integer and/or negative may also be used, mutatis mutandis.

Furthermore, the information obtained may include information indicative of more than one quantity of occurrences for some or all of the items, which pertain to different kinds of occurrences. Continuing the example of sample of cars, one counter of occurrences may be used for the number of times the car had to be sent to the central garage, while another counter may pertain to the number of times the car traveled 10,000 kilometers.

As aforementioned, the information obtained for each of the items of the set further includes information indicative of the quantity of successful occurrences of the item. Successful occurrences may be, for example, occurrences of the item that fulfill a condition that is indicative of an outcome of the occurrence.

As aforementioned, the information obtained for each of the items of the set further includes information indicative of one or more attributes of the item with regard to at least one variable out of a set of variables. The set of variables may include all of the variables by which the items are characterized in the sample. Since not all of the variables of the set may be applicable to all items, and since attributes of some items with respect to some of those variables may not be available, it is noted that the obtaining of stage 510 may include obtaining to one or more of the items attributes of that item with respect to a proper subset of the variables out of the set of variables which includes (in this example) all of the variables which are used to define items in the sample.

The defining of the classification scheme may include utilizing information about occurrences of a group of utilized items out of the set of items. As information about some items, especially those with zero occurrences, may be disregarded in some implementations, the group of utilized items may include fewer items than the sample. For samples in which at least some of the items have zero or few occurrences (i.e. are relatively scarce), a significant portion of items of the group of the utilized items may appear in the sample less than ten times.

For example, that portion may be larger than a quarter, larger than a half, larger than 80%, and so on. According to an embodiment of the currently presented subject matter, at least half of the items of the sample whose quantity of occurrences is larger than zero and whose information is used in the defining of the classification scheme appear in the sample less than ten times, inclusive. As in the above example, such a portion may be different than half, e.g. larger than a quarter, larger than a half, larger than 80%, and so on.

As will be demonstrated below in more detail, method 500 is useful when the quantity of successful occurrences of the various items is significantly large, and also useful when the quantity of successful occurrences of some (possibly most) of the items is low and even null—in contrast to prior art techniques.

It should be noted that the information indicative of the quantity of occurrences and/or of the quantity of successful occurrences may be used as other attributes of the items are used, in the following stages of method 500. Also, some of the information indicative of attributes of the various items may be obtained by a processing of other attributes of the item.

While not necessarily so, the attributes of each item may be constant over time (or at least change in a low change rate), while its performance indications (e.g. the quantity of occurrences, the quantity of successful occurrences, and the ratio between them) may vary between two samples in which the item is sampled.

Stage 520 of method 500 includes defining a classification scheme. The classification scheme is a classification scheme for classification of items into classes, wherein each item is classified into one (or more) of the classes based on its attributes with regard to at least one of the variables of the set. Referring to the examples set forth in the previous drawings, stage 520 may be carried out by a classification scheme determination module such as classification scheme determination module 230. The number of classes may be a predetermined number, or may be determined during the process of defining. As discussed below in greater detail, the defining of the classification scheme in stage 520 includes at least assigning a score to each variable out of at least one variable, based on a plurality of quantities of successful occurrences of items, each of the quantities is a quantity of successful occurrences having a corresponding attribute out of a plurality of attributes of the variable.

The defining of the classification scheme in stage 520 includes at least stages 521 and 522. Stage 521 is repeated for each one out of a plurality of variables (i.e. some or all of the variables), wherein the plurality of variables for which stage 521 includes, according to an embodiment of the currently presented subject matter, the at least one variable on which the classification scheme is based. In other implementations, however, some or all of the at least one variable on which the classification scheme is based may be derived from variables which are analyzed in stage 521.

Stage 521 includes computing for each out of a plurality of attributes of one of the variables, a success count of successful occurrences in the sample having said attribute. Optionally, stage 621 includes computing a success count of all of the successful redirections in the sample which have said attribute.

Reverting to FIG. 3, as illustrated by stage 522, the defining of the classification scheme in stage 520 is based on success counts computed for attributes of multiple variables. Some of the ways in which stage 520 may be implemented are discussed below in more detail, e.g. with respect to method 800. It should be noted that the classification scheme may be a deterministic classification scheme (in which items having similar attributes would always be treated the same), but this is not necessarily so.

Stage 530 of method 500 includes determining outcome estimations for classes that are defined by the classification scheme (e.g. one outcome estimation for each of the classes). It should be noted that applying the classification scheme to an item (based on its attributes) results in a selection of one (or more) out of a finite number of classes, to which outcome estimations are determined in stage 530.

The determining of the outcome estimations in stage 530 may include, be preceded by, or otherwise be based on a stage of applying the classification scheme to attributes of a plurality of items of the set (possibly to all of them), thereby obtaining for each out of a plurality of the classes a respective subset of the plurality of items. Variations of this stage are equivalents to those discussed with respect to stage 831 of method 800.

While the classification scheme may be used to define classes whose included items (in a single class) share something more than being included in a class to which a certain outcome estimation is assigned, this is not necessarily so. The former situation may be exemplified by the classification scheme, in which all of the items of a class may have similar performance (e.g. similar conversion rate). However, in other implementations this is not so. All the more so, even though a single outcome estimation is assigned to a class, that class may include items whose performance yields very different outcomes.

The outcome estimation determined for each class may be used to assign to items which are classified according to the classification scheme performance assessments which are based on the outcome estimation of the class to which each of those items it was classified. For example, in the example of keywords used in a search engine, the outcome estimation of each class may be a number between 0 and 1, and for each item a performance assessment which may be used as an assessment of the conversion rate in that geographic location may be assigned, based on the numerical outcome estimation determined to the class. Referring to the examples set forth in the previous drawings, stage 530 may be carried out by a class management module such as class management module 240.

The determining of the outcome estimation for a class in stage 530 may be based on the number of occurrences of some or all of the items in that class. For example, the determining of the outcome estimation for a class in stage 530 may be based on the sum of occurrences of all of the items of the sample which are classified to that class by application of the classification scheme.

The determining of the outcome estimation for a class in stage 530 may also be based (in addition to the formerly discussed number of occurrences of items in the class, or regardless thereof) on a count of multiple items in that class (which are classified to that class by applying the classification scheme to the attributes of those items). For example, while all of the items which are classified to that class based on the classification scheme may be counted in that count, in another implementation all and only items that have non-zero number of occurrences, are counted.

A more detailed discussion of some of the ways in which the conversion rate estimation may be determined in stage 530 is provided with respect to stage 830 of method 800. This discussion is not repeated with respect to method 500 for reasons of brevity only, and the variations discussed with respect to stage 830 may be implemented in stage 530, mutatis mutandis.

While not necessarily so, the determining of the outcome estimation in stage 530 may be irrespective of data pertaining to items of the sample which are not included in that class.

As will be discussed below in greater detail, method 500 may also include determining additional parameters for classes that are defined by the classification scheme, based on information of items of the samples which are classified to the respective classes.

Optional stage 540 of method 500 includes assigning to an analyzed item a performance assessment which is based on a performance estimate of a class out of the classes that is a result of an application of the classification scheme to attributes of the analyzed item. Referring to the examples set forth in the previous drawings, stage 540 may be carried out by a performance analysis module such as performance analysis module 250.

The assigning of the performance assessment to the analyzed item is based on both the classification scheme defined in stage 520 and on an outcome estimation determined in stage 530. For example, the classification scheme may be utilized for selecting the respective class by applying the classification scheme to the attribute of the aforementioned analyzed item. The outcome estimation of this class is then used in the determination of the performance assessment to be assigned to the analyzed item. In a sense, the classes may be considered as performance-indicative classes, since the outcome estimation which is associated with such a class is used in stage 540 to determine the performance assessment of the analyzed item which is classified to that class. While the performance assessment assigned to the analyzed item may be equal to the outcome estimation of the respective class, this is not necessarily so. In other implementations, that performance assessment may be based on additional parameters, such as attributes of the analyzed item.

It should be noted that stage 540 does not necessarily include direct application of the classification scheme to the attributes of the analyzed item. For example, stage 540 may be preceded by generating a performance assessment assignment scheme, based on the classification scheme. By way of example, the classification scheme includes a rule which states “if an item has attributes A1, B1, and C1 (of variables A, B, and C correspondingly), classify that item to class Q”. Assuming that in stage 530 an outcome estimation of 5% was determined for class Q, the generating of the performance assessment assignment scheme may include determining a performance assessment assignment rule stating: “if an item has attributes A1, B1, and C1 (of variables A, B, and C correspondingly), assign to that item the performance assessment 5%”, or ““if an item has attributes A1, B1, and C1 (of variables A, B, and C correspondingly), determine for that item a performance assessment which is a weighted average of 5% and the performance of that item in the sample”.

Stage 540 may include assigning a performance assessment to an item which is included in the training set, and may also include assigning a performance assessment to an item which is not part of the training set. Stage 540 may be repeated for assigning performance assessments to multiple analyzed items. For example, stage 540 may be repeated to assign performance assessments to all of the items in the sample, and possibly to other non-training items as well.

It should be noted that a quantity of occurrences and a quantity of successful occurrences is obtained for each of the items. Therefore, in at least some implementation, a crude performance assessment may be derived regardless of the classification scheme and classes.

In contrast, the outcome estimation of the class may be determined based on parameters which pertain to multiple items—such as some or all of the items of the training set which are classified to that class according to the classification scheme (e.g. the number of occurrences of the items classified to that class and a count of the items classified to that class which have more than one occurrence in the sample).

Method 500 may also include stage 550 of selectively applying one or more industrial processes in response to the performance assessment. Clearly, in different embodiments of the currently presented subject matter, different industrial processes may be applied. For example, stage 550 may include applying any appropriate combination of one or more of the following industrial processes:
A chemical industrial process (e.g. applying to the item an acid whose pH level is selected and/or manipulated based on the performance assessment, etc.);
A mechanical industrial process (e.g. applying to the item force of a magnitude which is linearly correlated to the performance assessment assigned to it, cutting another item in a pattern selected based on the performance assessment of the analyzed item, etc.);
A production industrial process (e.g. discarding the analyzed item and/or another item, based on the performance assessment assigned to the analyzed item);
An information technology industrial process (e.g. writing information to a database and/or tangible storage, modifying communication routing channel, encrypting, etc.);
Biological industrial process (e.g. determining which medicine to give to a sick cow, determine which nutritional additives should be added to the food of a group of animals, etc.); and so on.

If the item corresponds to a physical item (e.g. a car, a machine), the respective physical item may be treated based on its performance assessment. For example, in a fleet of cars, cars having the most assessed likelihood of requiring a costly procedure may be discarded, while cars having the lowest likelihood of a major repairs in the coming year may be selected for long distance rides. In another example, if the item is an ill person, an assessment of the likelihood of a relapse in his/her disease may be used in selecting which treatment should be given to such a patient.

The actions executed based on the performance assessment assigned to an item may not pertain to the item itself. For example, sawing parameters of a sawmill may be modified based on an assessing of the ratio of faulty lumber based on the attributes of the forest from which the trees are cut.

As aforementioned, method 600 may be just a variation of method 500, illustrated and discussed with relation to FIG. 3. Using the terms of method 500, optionally, each of the items is associated with item-associated Internet content; wherein for each of the items the quantity of occurrences corresponds to a quantity of item-associated redirections of Internet users to the item-associated Internet content associated with the item, and the quantity of successful occurrences of the item corresponds to a quantity of redirections which yielded reception of an indication of acceptance from the user.

Reverting now to FIG. 1B which illustrates an operation of the system of FIG. 1A, according to an embodiment of the currently presented subject matter. It is noted that the operation illustrated in FIG. 1B may be implemented by execution of one or more of the variations of method 500 (and of method 800, discussed below).

In the example illustrated in FIG. 1B, each of the items is a car 110. The set of items in this example is a group of cars (denoted 100). For example, the group of cars may include all of the cars in a fleet of a car rental company. The information pertaining to the cars 110 may be generated by system 200, or received from an external system or entity (not illustrated) via interface 205, as illustrated.

The information regarding the cars, which is stored in storage apparatus 210, is indicative for each of the cars 110 at least of: (a) a quantity of identified-occurrences (e.g. occurrences of a given type) of that car 110 in a sample (e.g. over a period of a year); (b) a quantity of successful occurrences of the car 110 in the sample; and (c) at least one attribute of that car 110 with regard to at least one variable out of a set of variables. Several optional variables are offered in the example of table 2A, but it is clear that other parameters and variables may also be obtained and utilized.

The classification scheme may be used for classifying cars into classes which are indicative of an expected number of times (possibly a fractional number) in which a cylinder head of a car is expected to be replaced within the next two years. The number of occurrences may be used for the number of times each of the cars 110 had to be sent to the central garage, or to the number of times in which that car traveled 10,000 kilometers.

Once classification scheme determination module 230 generated such a classification scheme (e.g. according to the techniques discussed above), class management module 240 may determine, with respect to each class of the plurality of classes, defined in the classification scheme, an outcome estimation, which is indicative of car performance. Continuing the example, the outcome estimation determined for each of the plurality of classes may be indicative of a likelihood (or expected number of times) in which a cylinder head of a car is expected to be replaced within the next two years.

Based on this data, performance analysis module 250 may analyze information of one or more cars 110 of a second group 100′, to assess an expectancy of performance of each of those cars 110. The second group 100′ may include some or all of the cars of group 100 (but necessarily so), and possibly additional cars as well.

Performance analysis module 250 is configured to compute for an analyzed car 110 a performance assessment which is based on the outcome estimation of a classification which is based on the attributes of that analyzed car 110 (and on the classification scheme). For example, performance analysis module 250 may apply the classification scheme determined by classification scheme determination module 230 (or another classification scheme, derived for this one), to classify the cars 110 of group 100′ into multiple classes (in the example there are two classes—class 120′ and class 120″).

Each of the classes 120′ and 120″ is associated with an outcome estimation determined for it by class management module 240 (e.g. 1% and 0.1%, respectively). Based on outcome estimation and possibly also on the parameter of each of the analyzed cars 110 (i.e. their attributes), performance analysis module 250 determines for each of the analyzed cars 110 a respective performance assessment.

Process management module 260 in the illustrated example is configured to manage an industrial process in which cars 110 to which high expectancy of a significant failure is computed (by performance analysis module 250) are sent for a pre-emptive mechanical treatment in a garage (denoted 190). As can be seen, even though different classes 120 are associated with different outcome estimations, a differentiation of performance assessments computed for cars 110 of different classes do not necessarily correspond directly to the classification.

In this example, performance assessments which are lower than a given threshold (below which cars are sent to the garage) is computed for cars 110 of the two classes 120 (such cars 110 are highlighted in the diagram). This may be a result of the different parameters of each of the cars, and especially it may be a result of information pertaining to previous performance data. For example cylinder head on an old car 110 was already replaced thrice (which is very uncommon), even though such a car 110 may be classified to a class with a lower outcome estimation (e.g. class 120″ in the illustrated example).

It will be clear that apart from the selective application of the industrial process which is enabled in the illustrated example (the selective application being responsive to the performance assessment), other industrial processes may also be applied to such cars 110 (or other items).

FIGS. 4A and 4B illustrate computerized classification method 800, according to an embodiment of the currently presented subject matter. Stage 810 of method 800 corresponds to stage 510 of method 500, stage 820 to stage 520, stage 830 to stage 530, stage 840 to stage 540, and stage 850 to stage 550. The discussion which pertains to one of stages 510, 520, 530, and 530 of method 500 is considered to be disclosed as a possible implementation (unless inapplicable) of the corresponding stage of method 800, and vice versa, even if not explicitly elaborated.

Referring to the examples set forth in the previous drawings, method 800 may be executed by a system such as system 200. Embodiments, variations and possible implementations discussed with relation to method 800 may be applied to system 200 mutatis mutandis even if not explicitly elaborated, and vice versa.

Referring now to stage 820, which corresponds to stage 520 of method 500 and which includes defining a classification scheme for classification of items into classes based on at least one of the variables.

Stage 820 includes computations which are carried out for different attributes of each one out of a plurality of variables (some or all of the variables of the set). As with methods 500 and 600, the attributes may be divided into multiple subsets, wherein in such cases the required modifications are applied to method 800.

Therefore, stage 820 may include optional stage 821 of obtaining a division of attributes of a given variable into multiple subsets of attributes. As is discussed below, stage 821 is repeated for several variables. The division may be obtained from an external entity (e.g. they may be defined by a human expert), and may also be determined as part of the method. For example, method 800 may include trying out several divisions, and selecting a division which yields better results. In another example, method 800 may include determining the division based on an analysis of data of the sample. If stage 821 is carried out, each of the subsets may be considered as an attribute of its own in the following stages.

Optional stage 821 may also include grouping the occurrences of the sample into variable-based subsets, each of which includes all of the occurrences of the sample whose attribute is included within one of the subsets of attributes. For example, the distribution of the variable Length may be to the following subsets—

Subset LENGTH1={1 . . . 39};

Subset LENGTH2={40 . . . 69};

Subset LENGTH3={>70}

Stage 822 of method 800 includes computing for one of the attributes a quantity of occurrences of items having said attribute. Stage 822 is repeated for some or all of the attributes of the given variable. It is noted that more than one quantity of occurrences may be calculated for each attribute, and that quantities of occurrences may be computed differently in different embodiments of the currently presented subject matter.

For example, stage 821 may include calculating for the attribute a quantity of successful occurrences of items having said attribute. Furthermore, stage 821 may include calculating for the attribute a quantity of all of the successful occurrences of items in the sample (or in a subset thereof) having said attribute. For example, while in some implementations the quantity of successful occurrences may indicate the overall number of successful occurrences of items in the sample having said attribute, in another implementation the quantity of successful occurrences may only be calculated for the first 100,000 items (or first 100,000 occurrences) because of memory limitations.

For example, stage 821 may include calculating for the attribute a quantity of unsuccessful occurrences of items having said attribute (for each item, the quantity of unsuccessful occurrences may be calculated as the difference between the quantity of occurrences to the quantity of successful occurrences). Furthermore, stage 821 may include calculating for the attribute a quantity of all of the unsuccessful occurrences of items in the sample (or in a subset thereof) having said attribute. For example, while in some implementations the quantity of unsuccessful occurrences may indicate the overall number of unsuccessful occurrences of items in the sample having said attribute, in another implementation the quantity of unsuccessful occurrences may only be calculated for the first 100,000 items (or first 100,000 occurrences) because of memory limitations.

For example, stage 821 may include calculating for the attribute a quantity of occurrences of items having said attribute. Furthermore, stage 821 may include calculating for the attribute a quantity of all of the occurrences of items in the sample (or in a subset thereof) having said attribute. For example, while in some implementations the quantity of occurrences may indicate the overall number of occurrences of items in the sample having said attribute, in another implementation the quantity of occurrences may only be calculated for the first 100,000 items (or first 100,000 occurrences) because of memory limitations.

Without limiting the scope of the currently presented subject matter, in the following discussion, the method is primarily exemplified referring to implementations in which such quantities of occurrences pertain to summing of occurrences from the entire sample (or from subsets of the sample which are defined only on an attribute based division, e.g. as exemplified with respect to stage 828).

Reverting to the success count, the success count may be a count of the quantity of successful occurrences of all the items in the variable based subset (i.e. all of the items in the sample whose attribute belongs to the subset of attributes).

As aforementioned, stage 822 may also include computing for the attribute (or variable-based subset) an occurrences count of all of the occurrences in the sample having said attribute. In such an implementation the occurrences count may be a count of the quantity of occurrences of all the items of the sample having said attribute.

As aforementioned, stage 822 may also include computing for the attribute a fail count of all of the occurrences in the sample which are not successful. The fail count in such an implementation is equal to the difference between the occurrences count and the success count.

The defining of the classification scheme may be facilitated by stage 823 of calculating a score for the attribute, based on the success count, the fail count, the occurrences count, or a combination thereof. Possibly, the calculating of the attribute-score in stage 823 may be based on other parameters as well.

The calculating of the attribute-score in stage 823 may include calculating an information entropy value for the attribute. For example, the calculating of entropy in stage 823 (if implemented) may include determining the attribute-value E(s) for the attribute, so that

$$E ( s ) = - {\sum }_{j = 1}^{n} {f}_{s} ( j ) {log}_{2} {f}_{s} ( j ) ,$$

wherein the different values j are the possible outcomes of each occurrence, and f_{S}(j) is the proportion of the value j in the set S.

If, as in the example above, only two general types of outcome are considered (successful occurrence and unsuccessful occurrence), the value E(s) may be determined as E(s)=−fₛ(success)·log₂ fₛ(success)−fₛ(fail)·log₂ fₛ(fail), which is equal to:

$$E ( s ) = - \frac{{N}_{success}}{{N}_{occurrence}} \cdot {log}_{2} ( \frac{{N}_{success}}{{N}_{occurrence}} ) - \frac{{N}_{fail}}{{N}_{occurrence}} \cdot {log}_{2} ( \frac{{N}_{fail}}{{N}_{occurrence}} )$$

It will be obvious that some variations on these formulae may be implemented if they are considered, for example, to simplify the calculations. For example, logarithms of different bases may be used; the negative computation may be replaced with a computation of positive numbers, and so on. The attribute-score calculated for one or more of the attributes is not necessarily an entropy, and may depend on parameters other than the aforementioned counts (in addition to or instead of those one or more counts). Also, if more than two types of outcome are considered, the entropy (or other attribute-score) may be responsive to information pertaining to more than two types of outcomes.

Once scores are calculated for the two or more (possibly all) of the attributes which are based on the division of the attributes of the given variable, a variable-score may be computed for the given variable, based on one or more of the attribute-scores.

Optional stage 824 of method 800 includes computing for the given variable a variable-score, based on the scores of the plurality of attributes. This variable-score may be later used in the defining of the classification scheme (e.g. by utilizing a comparison between the variable-scores of at least two of the multiple variables). The computing of the variable score in stage 824 may be further based on additional parameters, such as the relative sizes of the different variable-based sets.

For example, the variable-score may be computed by:

$$VS ( V ) = {\sum }_{i = 1}^{m} fs ( {A}_{i} ) \cdot E ( {S}_{Ai} )$$

where VS(V) is the variable-score of the given variable V over the sample S. E(S) is the information entropy of the entire sample S. m is the number of the attributes of V. f_{S}(Ai) is the proportion of the items which belong to attribute i, and E(S_{Ai}) is the attribute-score of the i'th attribute (e.g. its entropy).

It will be obvious that some variations on this formula may be implemented if it is considered, for example, to simplify the calculations. The variable-score computed for the given variable may be some variation on the Kullback-Leibler divergence, information divergence, information gain, relative entropy, etc. as those are known in the art, but this is not necessarily so. The computing of the variable-score VS(V) for the given variable may depend on parameters other than those discussed with respect to the example formula.

It should be noted that a variable-score for a variable is not necessarily computed based on attribute-scores as discussed above, but may otherwise be computed. The computing of the variable score (whether based on attribute-scores of several attributes or not) may be repeated for several variables (denoted stage 825 in FIG. 4A).

Method 800 may continue with stage 826 of selecting a variable out of the variables, based on the variable-scores assigned to them. For example, the variable for which the highest (or alternatively the lowest) variable-score was computed may be selected.

At each level, once a variable has been selected, method 800 may include stage 827 of including as the next hierarchy of the classification scheme a classification which is based on the selected variable and on its variable-based sets of attributes.

If stage 822 is repeated for computing for each out of a plurality of the attributes a success count of all of the successful occurrences in the sample having said attribute; method 800—and especially the defining of the classification scheme in stage 820—may further include:

computing for each of the plurality of attributes of each of the multiple variables a fail count of all of the occurrences in the sample whose attribute belongs to the attribute and which are not successful occurrences;

computing for each of the plurality of attributes of each of the multiple variables an attribute-score, based on the success count, on the fail count, and on a number of all occurrences in the sample having that attribute; and possibly also computing for each one of the multiple variables a variable-score based on the attribute-scores of the plurality of attributes of that variable.

In such a case, the defining of the classification scheme may be based on the variable-scores of at least two of the multiple variables.

Stage 820 may further include stage 8210 that includes validating parts or all of the classification scheme. The validating may include classifying some items (whether of the trial set or not), and applying some validation criteria to see whether the generated classes of items are sufficiently useful. The validation may also be applied at a later stage of method 800.

It should be noted that while not necessarily so, the classification scheme (or at least the way in which it is executed) may include guides as to what to do if a analyzed item does not have information regarding some of the variables, or other similar problems.

It should be noted that since the classification scheme is based on attributes, the same classification scheme may be applied to occurrences as well as to items. That is, in a sense, occurrences may be classified independently of the items.

Stage 830 of method 800 includes determining an outcome-estimation for classes that are defined by the classification scheme. As aforementioned with respect to method 500, method 800 may also include determining additional parameters for classes that are defined by the classification scheme, based on information of items of the samples which are classified to the respective classes. While not necessarily so, the calculating of the outcome estimation and/or the additional parameters determined for a class is irrespective of data pertaining to items of the sample which are not included in that class.

Stage 830 may start with stage 831 of classifying items of the sample into the different classes, based on the defined classification scheme. It is noted that if the classification scheme is subject to validation, the classification scheme used for the determining of stage 830 may not be the final one defined in the method, as some refinements or corrections may be applied to it. It is noted that stage 831 may include classifying into the classes either the items and/or their occurrences.

It is noted that stage 831 may include classifying all of the items of the sample, or only part of them. For example, in some implementations, items having zero occurrences are not necessarily classified.

Stage 831 may be followed by stage 832 that includes determining an outcome estimation for a class based on information pertaining to the items of the sampled classified to that class in stage 831, such as the number of occurrences and/or on a count of multiple items in that class.

Method 800 may also include determining of one or more additional parameters for each class. For example, optional stage 833 includes determining a reliability index for a class based on information pertaining to the items of the sampled classified to that class in stage 831, such as the number of occurrences and/or on a count of multiple items in that class.

The determining of the outcome estimation and the optional additional parameters may be repeated for some or all of the classes. For example, the outcome estimation may be the total number of successful occurrences of the items in the class by the total number of occurrences of the items in the class.

A few other examples of ways in which the outcome estimation may be determined may be based on the examples provided by M. U. Kalwani in an article entitled “Maximum Likelihood Estimation of Zero-Order Models Given Variable Numbers of Purchases Per Household” (published in the Journal of Marketing Research, Vol. 17, No. 4 (November, 1980), pp. 547-551). In but one example, the determining of the outcome estimation may be based on equation 6 in that article, by maximizing the following expression:

$$L ( {n}_{x}^{k} \vert μ , φ , {k}^{′} s ) = {\sum }_{x = 0}^{K} [ {\sum }_{x = 0}^{k} {n}_{x}^{k} \{ \begin{matrix}{\sum }_{r = 0}^{x - 1} log [ μ ( 1 + φ ) + r φ ] + \\ {\sum }_{r = 0}^{k - x - 1} log [ ( 1 - μ ) ( 1 - φ ) + r φ ] - \\ {\sum }_{r = 0}^{k - 1} log ( 1 - φ + r φ )\end{matrix} \} ]$$

In the terms of the present disclosure, the log likelihood function L is based on the parameters μ and φ and multiple k's. k indicates the number of occurrences of an item. In the sample, items may have different numbers of occurrences, and it is assumed that the maximal number of occurrences of a single item is K. nₓ^{k} is the number of items with x successful occurrences out of k occurrences of that item.

Since the nₓ^{k} 's are known in advance (from the obtained information of the sample), the only parameters by which L may be maximized are μ and φ. In this example, the outcome estimation of the class (and the possible additional parameters) may be based on the values of those parameters.

For example, the outcome estimation of the class may be equal to μ (S=μ), and the reliability index may be defined based on φ (e.g. T=1/(1+φ)). In an example, the final parameters T and S are set for all valid nodes: S is the maximum likelihood value computed in step 1, T is the larger of: (a) the maximum likelihood value computed; and (b) minimum T value for node, which depends on the value of S and a tolerance threshold.

It is noted that the validation of the classification scheme may also follow (or be integrated with) the determining of the outcome estimation (denoted stage 835). For example, classes for which an outcome estimation may not be determined with sufficient reliability may be canceled, and the classification scheme may be modified accordingly.

It should be noted that in the aforementioned article of Kalwani, the parameters are not used for validation of a classification, nor it is used for a Bayesian function for computation of performance assessment (such as conversion rate assessment).

Addressing methods 500, 600 and 800, as well as system 200, it is noted that the proposed methods and systems may be based on Bayesian statistics, in which the evidence about the true state of the world is expressed in terms of Bayesian probabilities.

In at least some of the embodiments of the disclosed methods and systems (as disclosed above), the classification (and the classification scheme) is based on attributes which are not dependent on the performance (e.g. conversion rate) of the different items of the training set.

In opposition to classic decision trees, the disclosed methods and systems may be used to assigning to items performance estimates which are different than those which are reflected in the sample.

It will also be understood that the system according to the currently presented subject matter may be a suitably programmed computer. Likewise, the invention contemplates a computer program being readable by a computer for executing the method of the invention. The invention further contemplates a machine-readable memory tangibly embodying a program of instructions executable by the machine for executing the method of the currently presented subject matter.

Reverting to the discussion of system 200 (illustrated in FIG. 1A), it is noted that as aforementioned, embodiments, variations and possible implementations discussed with relation to any of methods 500, 600, and 800 may be applied to system 200 mutatis mutandis even if not explicitly elaborated. Some such variations are provided below as examples, but it is noted that implementations of system 200 are not limited to those discussed below.

Optionally, the defining process implemented by classification scheme determination module 230 may include assigning a score to each out of a plurality of attributes of a plurality of variables of the set, based on a quantity of occurrences of items having said attribute. Optionally, the defining of the classification scheme is irrespective of a success rate of any item of the set of items.

As discussed with respect to the aforementioned methods, system 200 may be effectively utilized in many situations, and among those in situations in which occurrences of a relatively large part of the items are scarce. Optionally, at least half of the items of the sample whose quantity of occurrences is larger than zero and whose information is used in the defining of the classification scheme appear in the sample less than ten times.

As discussed with respect to the aforementioned methods, system 200 may be effectively utilized in many situations, and among those in situations in which the items are related to electronic advertising. For example, method 200 may be implemented in electronic advertising in that each occurrence is an impression, i.e. a display of an advertisement to a user. The impression (i.e. the displaying of the ad) may result from:
Keyword searching by the user in a search engine;
Social media advertising (e.g. basing the decision of the impression on demographics of a user to which the ad is displayed, wherein the trigger may be a usage the user made to a social media website);
Electronic newsletter (e.g. e-mail) sent to registered user (or other users listed in a mailing-list), e.g. based on a decision of a marketer; etc.

In implementations in which the defining process implemented by classification scheme determination module 230 includes assigning a score to each out of the plurality of attributes of a plurality of variables, classification scheme determination module 230 may be configured to execute one or more of the following processes:
Assigning the score to each out of the plurality of attributes based on a quantity of successful occurrences of items having said attribute.
Assigning the score to each of the plurality of attributes based on a quantity of all of the successful occurrences of items having said attribute.
Assigning the score to each out of the plurality of attributes based on a quantity of unsuccessful occurrences of items having said attribute.
Computing the score to each of the plurality of attributes based on: (a) a quantity of all of the successful occurrences which are associated with said attribute in a subset of the sample, (b) a quantity of all of the occurrences in the subset which are associated with said attribute and which are not successful occurrences; and (c) a quantity of all of the occurrences in the subset which are associated with said attribute.
Computing for each one of the plurality of the variables a variable-score based on the scores assigned to at least two of the attributes of said variable, wherein the defining of the classification scheme is based on the variable-scores of at least two of the plurality of variables.

While certain features of the currently presented subject matter have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions falling within the scope of the invention, as defined in the appended claims.

What is claimed is:

1. A system for classification, the system comprising:
(a) at least one storage apparatus configured to store information pertaining to a set of ad entity performance data associated with different geographic locations, the information being indicative of:
a quantity of occurrences, larger than one, of the performance data in a sample,
a quantity of successful occurrences of the performance data in the sample, and
at least one geographic location identifier of the performance data; and
(b) at least one processor configured to:
define a classification scheme for classification of the performance data into classes based on at least the geographic location identifier in a defining process which includes assigning a score to the geographic location identifier, based on a plurality of quantities of successful occurrences of performance data, each of the quantities is a quantity of successful occurrences having a corresponding geographic location identifier,
obtain a respective subset of the performance data for each out of a plurality of the classes, by applying the classification scheme to geographic location identifiers of a plurality of performance data of the set,
determine, with respect to each class of the plurality of classes, an outcome estimation based on quantities of successful occurrences of performance data of the respective subset of performance data of said class, and
compute, for an analyzed performance data, a performance assessment which is based on an outcome estimation of a class out of the classes that is a result of application of the classification scheme to geographic location identifiers of the analyzed performance data, thereby enabling a selective application of an industrial process, wherein the selective application is responsive to the performance assessment.

2. The system according to claim 1, wherein each occurrence is partial performance data associated with one of said different geographic locations, and each successful occurrence is complete performance data associated with one of said different geographic locations.

3. The system according to claim 1, wherein the selective application comprises determining a geographic bid modifier for an ad entity

4. The system according to claim 3, wherein the determining of the geographic bid modifier for the ad entity comprises computing a ratio between:
a value per click for the ad entity; and
an average value per click across ad entities of all the different geographic locations.

5. The system according to claim 4, wherein the value per click and the average value per click are at least partially based on a geographic parameter selected from the group consisting of: a demographic parameter, a business parameter associated with an advertiser, a geographic reach of an advertising platform, weather data and news data.

6. The system according to claim 3, wherein the determining of the geographic bid modifier for the ad entity comprises computing a ratio between:
a value per impression for the ad entity; and
an average value per impression across ad entities of all the different geographic locations.

7. The system according to claim 6, wherein the value per impression and the average value per impression are at least partially based on a geographic parameter selected from the group consisting of: a demographic parameter, a business parameter associated with an advertiser, a geographic reach of an advertising platform, weather data and news data.

8. The system according to claim 1, wherein the ad entity is selected from the group consisting of: an individual ad, a set of ads, a campaign and a set of campaigns.

9. The system according to claim 1, wherein the performance data comprises at least one performance metric selected from the group consisting of: impressions, clicks, click-through rate (CTR), conversions, return on investment (ROI), revenue per click, cost per impression, cost per click, revenue per impression, reach and frequency.

10. The system according to claim 3, wherein said at least one processor is further configured to transmit a command to an advertising platform, the command being based on the geographic bid modifier for the ad entity.

11. A computerized method for classification, the method comprising:
(a) storing, in at least one storage apparatus, information pertaining to a set of ad entity performance data associated with different geographic locations, the information being indicative of:
a quantity of occurrences, larger than one, of the performance data in a sample,
a quantity of successful occurrences of the performance in the sample, and
at least one geographic location identifier of the performance data; and
(b) using at least one processor to:
define a classification scheme for classification of the performance data into classes based on at least the geographic location identifier in a defining process which includes assigning a score to the geographic location identifier, based on a plurality of quantities of successful occurrences of performance data, each of the quantities is a quantity of successful occurrences having a corresponding geographic location identifier,
obtain a respective subset of the performance data for each out of a plurality of the classes, by applying the classification scheme to geographic location identifiers of a plurality of performance data of the set,
determine, with respect to each class of the plurality of classes, an outcome estimation based on quantities of successful occurrences of performance data of the respective subset of performance data of said class, and
compute, for an analyzed performance data, a performance assessment which is based on an outcome estimation of a class out of the classes that is a result of application of the classification scheme to geographic location identifiers of the analyzed performance data, thereby enabling a selective application of an industrial process, wherein the selective application is responsive to the performance assessment.

12. The method according to claim 11, wherein each occurrence is partial performance data associated with one of said different geographic locations, and each successful occurrence is complete performance data associated with one of said different geographic locations.

13. The method according to claim 10, wherein the selective application comprises determining a geographic bid modifier for an ad entity.

14. The method according to claim 13, wherein the determining of the geographic bid modifier for the ad entity comprises computing a ratio between:
a value per click for the ad entity; and
an average value per click across ad entities of all the different geographic locations.

15. The method according to claim 14, wherein the value per click and the average value per click are at least partially based on a geographic parameter selected from the group consisting of: a demographic parameter, a business parameter associated with an advertiser, a geographic reach of an advertising platform, weather data and news data.

16. The method according to claim 13, wherein the determining of the geographic bid modifier for the ad entity comprises computing a ratio between:
a value per impression for the ad entity; and
an average value per impression across ad entities of all the different geographic locations.

17. The system according to claim 16, wherein the value per impression and the average value per impression are at least partially based on a geographic parameter selected from the group consisting of: a demographic parameter, a business parameter associated with an advertiser, a geographic reach of an advertising platform, weather data and news data.

18. The method according to claim 11, wherein the ad entity is selected from the group consisting of: an individual ad, a set of ads, a campaign and a set of campaigns.

19. The method according to claim 11, wherein the performance data comprises at least one performance metric selected from the group consisting of: impressions, clicks, click-through rate (CTR), conversions, return on investment (ROI), revenue per click, cost per impression, cost per click, revenue per impression, reach and frequency.

20. The method according to claim 13, wherein said at least one processor is further configured to transmit a command to an advertising platform, the command being based on the geographic bid modifier for the ad entity.

21. A program storage device readable by machine, tangibly embodying a program of instructions executable by the machine to perform a method for classification, comprising the steps of:
(a) storing, in at least one storage apparatus, information pertaining to a set of ad entity performance data associated with different geographic locations, the information being indicative of:
a quantity of occurrences, larger than one, of the performance data in a sample,
a quantity of successful occurrences of the performance in the sample, and
at least one geographic location identifier of the performance data; and
(b) using at least one processor to:
define a classification scheme for classification of the performance data into classes based on at least the geographic location identifier in a defining process which includes assigning a score to the geographic location identifier, based on a plurality of quantities of successful occurrences of performance data, each of the quantities is a quantity of successful occurrences having a corresponding geographic location identifier,
obtain a respective subset of the performance data for each out of a plurality of the classes, by applying the classification scheme to geographic location identifiers of a plurality of performance data of the set,
determine, with respect to each class of the plurality of classes, an outcome estimation based on quantities of successful occurrences of performance data of the respective subset of performance data of said class, and
compute, for an analyzed performance data, a performance assessment which is based on an outcome estimation of a class out of the classes that is a result of application of the classification scheme to geographic location identifiers of the analyzed performance data, thereby enabling a selective application of an industrial process, wherein the selective application is responsive to the performance assessment.

22. The program storage device according to claim 21, wherein each occurrence is partial performance data associated with one of said different geographic locations, and each successful occurrence is complete performance data associated with one of said different geographic locations.

23. The program storage device according to claim 21, wherein the selective application comprises determining a geographic bid modifier for an ad entity.

24. The program storage device according to claim 23, wherein the determining of the geographic bid modifier for the ad entity comprises computing a ratio between:
a value per click for the ad entity; and
an average value per click across ad entities of all the different geographic locations.

25. The program storage device according to claim 23, wherein the value per click and the average value per click are at least partially based on a geographic parameter selected from the group consisting of: a demographic parameter, a business parameter associated with an advertiser, a geographic reach of an advertising platform, weather data and news data.

26. The program storage device according to claim 23, wherein the determining of the geographic bid modifier for the ad entity comprises computing a ratio between:
a value per impression for the ad entity; and
an average value per impression across ad entities of all the different geographic locations.

27. The program storage device according to claim 26, wherein the value per impression and the average value per impression are at least partially based on a geographic parameter selected from the group consisting of: a demographic parameter, a business parameter associated with an advertiser, a geographic reach of an advertising platform, weather data and news data.

28. The method according to claim 21, wherein the ad entity is selected from the group consisting of: an individual ad, a set of ads, a campaign and a set of campaigns.

29. The program storage device according to claim 21, wherein the performance data comprises at least one performance metric selected from the group consisting of: impressions, clicks, click-through rate (CTR), conversions, return on investment (ROI), revenue per click, cost per impression, cost per click, revenue per impression, reach and frequency.

30. The program storage device according to claim 23, wherein said at least one processor is further configured to transmit a command to an advertising platform, the command being based on the geographic bid modifier for the ad entity.
